(19) United States
(12) Patent Application Publication
(10) Pub. No.: US 2015/0330137 A1
(43) Pub. Date: Nov. 19, 2015

(54) INSULATING GLASS WINDOW HAVING HIGH THERMAL INSULATION AND REDUCED TRANSMISSIVITY FOR IR RADIATION

(71) Applicant: Bayer MaterialScience AG, Monheim Am Rhein (DE)

(72) Inventors: Alexander MEYER, Düsseldorf (DE); Timo KUHLMANN, Leichlingen (DE); Rafael OSER, Krefeld (DE)

(73) Assignee: Bayer MaterialScience AG, Monheim Am Rhein (DE)

(21) Appl. No.: 14/648,965

(22) PCT Filed: Nov. 29, 2013
(86) PCT No.: PCT/EP2013/075033

§ 371 Date: Jun. 2, 2015

(30) Foreign Application Priority Data
Dec. 4, 2012 (EP) 12195481.2

(51) Int. Cl. E06B 3/67; B32B 17/10

(52) U.S. Cl. CPC E06B 3/6715; B32B 17/10752; B32B 2250/03; B32B 2250/40; B32B 2255/10; B32B 2307/304; B32B 2419/00; B32B 2605/08; B32B 2605/18

(57) ABSTRACT

The invention relates to insulating glass units having high thermal insulation and reduced transmissivity for IR radiation comprising at least two spaced-apart glass panes and at least one spaced-apart sheet of special polycarbonate containing a gas mixture within these units.

The invention relates to insulated glazing units providing a high level of thermal insulation and providing reduced permeability to IR radiation made of at least two glass panes at a distance from one another, and of, at a distance therefrom, at least one pane made of specific polycarbonate comprising a gas mixture within said units.

Insulating glass windows make a major contribution to the reduction of heat consumption for heating of buildings. They also provide acoustic insulation, as well as thermal insulation.

The thermal resistance 1/Λ of a component serves for assessment of thermal insulation, and the heat transmission coefficient k serves for assessment of heat loss by transmission from buildings. The heat transmission coefficient k is calculated from the thermal resistance 1/Λ with reference to the heat transmission resistance values α_{i/a} on the internal and, respectively, external side by using

$$k = \frac{1}{\frac{1}{{α}_{i}} + \frac{1}{Λ} + \frac{1}{{α}_{a }}} .$$

The equation for multiple glazing is

$$\frac{1}{k} = \frac{1}{{k}_{1}} + \frac{1}{{k}_{2}} + \frac{1}{{k}_{3}} + …$$

Heat loss through insulating multiple glazing is composed of two components: the loss due to transmitted heat and the loss due to radiant heat.

Heat transmission through an insulating multiple glazing unit is determined by the thermal resistance of the glass and of the filler gas. Heat radiated through an insulated glazing unit is determined by the optical properties of the glass panes. When standard glass is used, there is practically no hindrance to passage of solar thermal radiation (NIR region) through the pane.

Thermal insulation is subject to increasingly stringent requirements. Thermal insulation regulations have been revised accordingly. The aim of these regulations (e.g. the Energieeinsparverordnung EnEV in Germany or the European Union's EnergyStar Program) is to minimize heat losses for entire buildings. This means that the thermal insulation properties of the individual components have to be selected in such a way as to avoid exceeding the prescribed k value for the entire building. The window areas have a large effect on the k value of the entire building because the k value of the windows is substantially poorer than that of the masonry. The use of double or multiple glazing systems with air between the panes has already provided substantial improvements over glazing systems using single glazing: the k value of 5.7 W/m²K for single glazing has been reduced to 3.0 W/m²K for double glazing and as far as 2.0 W/m²K for triple glazing.

Suitable coating of the glass panes has significantly reduced the k value. The coatings usually used nowadays are multilayer systems comprising at least one metal layer based on gold, silver, copper, indium, tin, or aluminum, the thickness of these being a few nanometers. These systems—also termed low-E layers or solar-control layers—are disadvantageously susceptible to corrosion. When used as solar-control layer they are moreover detrimental to the appearance of buildings, since this layer always alters the reflection and transmission of light in the visible region. It is moreover difficult and therefore expensive to apply said low-E or solar-control layers to the glass.

The triple glazing of the prior art, made of glass, is moreover much heavier than double elements. It is therefore sometimes necessary to reinforce frame elements, for example door frames or window frames, so that these do not distort during opening of the window or of the door. Moreover the transport and handling of these heavy glazing systems require extensive effort.

Even in triple glazing there is the possibility of glass breakage as a consequence of external effects such as storm damage, vandalism, etc. Glazing systems of this type do not therefore provide effective burglary prevention.

Said glazing systems also transmit a high proportion of UV light. This can lead to bleaching of interiors, e.g. floors or furniture.

It is an object of the invention to provide an insulated glazing unit which has good thermal insulation properties and simultaneously reduced transmission of NIR without, by way of example, any need for integration of an expensive metal layer. For the purposes of the present invention, NIR means transmission in the near region of the infrared spectrum from 780 nm to 2500 nm. The element is moreover intended to be less heavy than the corresponding triple glazing systems of the prior art made of glass, and to be highly capable of resisting external effects such as attempted burglaries. The window element is moreover intended to exhibit low UV transmission, expressed as optical density greater than or equal to 1 at wavelength 340 nm, preferably greater than or equal to 1.5, particularly preferably greater than or equal to 2. It is moreover important that these properties remain substantially constant over a long period, and do not undergo any drastic change when exposed to the effects of weather. The structure of the element is moreover intended to provide maximal light transmission with maximal color neutrality.

Windows consisting of glazing systems which comprise thermoplastic materials—inter alia polycarbonate—are in principle known.

Glazing systems comprising thermoplastics, such as polyvinyl butyral, are known and widely described. However, these systems, as used in vehicle construction, do not serve for thermal insulation. Other requirements are of prime importance here, for example safety of the vehicle occupants. These systems are not appropriate to the object described here or to the production of insulating glass windows.

DE 2515393 describes sandwich structures which also comprise polycarbonate sheets, in addition to glass. However, no insulating glazing systems are described here. Nor is there any description of elements comprising specific filler gases. DE 2515393 does not disclose any glazing that features low permeability to IR radiation. WO1991002133 describes a multiple glazing system comprising at least 2 IR-reflective foils based on metal layers. 2 glass panes here enclose the reflective foils. This system has the disadvantage that the reflective foils do not retain their dimensions when exposed to heat, and undesired optical effects are therefore produced. Another disadvantage with the use of the reflective foils is the electromagnetic shielding due to the metal layers used.

U.S. Pat. No. 6,265,054 relates to glazing systems comprising transparent plastics sheets; these systems feature low weight and high modulus. However, no insulating glass windows are described. There is no description of any systems featuring low energy permeability. U.S. Pat. No. 6,265,054 does not reveal how the problem described is to be solved.

U.S. Pat. No. 5,589,272 bonds thermoplastic materials to one another directly, i.e. with no intervening gas layer. The glass layers here are very thin, and are intended merely to ensure that the system is scratch-resistant. In contrast, the present application concerns insulating glass windows; the individual panes are not in direct contact with one another—they have not by way of example been laminated to one another. Another lamination approach is described in U.S. Pat. No. 4,600,640.

EP 963171 describes window systems consisting of two external glass panes and an internal splitterproof pane, preferably made of polycarbonate. These systems differ in the functional layers from the system described here. The systems described in EP 963171 cannot reduce energy transmission. There is moreover no description of any insulating glazing systems with appropriate filler gases. EP 963171 does not reveal how the object defined here is to be achieved.

WO 9633334, DE 60029906, WO 02/29193, and WO 98/34521 all describe various designs of insulating triple-glazing systems comprising a polycarbonate pane arranged between, and at a distance from, two glass panes. There is no mention of use of fillers or pigments in the polycarbonate pane. Furthermore, no reference is made to any improvement of IR-protective effect through addition of relevant additives. EP 2213490 describes automobile glazing which comprises fine-particle fillers or pigments in order to improve IR-protective effect. There is no mention of the use of glazing modified in that way in an insulating triple-glazing system, or of the appropriate positioning of any such modified glazing if it were to be used.

EP 1865027 relates to borides in polycarbonate resin compositions inter alia for use in glazing systems. There is no mention of the use of polycarbonate resin compositions of this type in insulating glazing systems. The intrinsic color of the borides moreover prevents achievement of the object of the present invention: provision of a system with high light transmission with good color neutrality.

JP 2008214596 reports the use of tungsten oxides in polycarbonate resin compositions for purposes of improvement of IR-protective effect. There is no mention of the use of these modified polycarbonates as glazing in insulating glazing systems. There is moreover no reference to the essential requirement that the modified sheet be installed between 2 glass panes in order to achieve a long-term IR-protective effect. That approach does not therefore achieve the object of the present invention.

GB 1328576 likewise describes glazing systems comprising thermoplastic materials. Said glazing systems do not, however, exhibit the low energy transmission described here. Nor is it obvious how low energy transmission could be achieved.

All of the abovementioned documents describe window designs comprising thermoplastic materials. However, these sources do not enable the person skilled in the art to discover how the present object could be achieved. The person skilled in the art would adopt the theoretical ideas from the prior art, but the available prior art would not permit achievement of the required low energy transmission. Although all of the abovementioned documents describe theoretical ideas, they still fail to provide clarity, and the person skilled in the art therefore has an enormous number of possibilities for the design of glass-plastics composites of this type. Said documents do not describe the manner in which the object is presently achieved.

The prior art likewise provides many alternative approaches for preventing the passage of radiant heat through a window: IR-reflective layers or pigments, or IR-absorbent pigments, can be used. By way of example Schelm et al. in Applied Physics Letter, 2003, vol. 82 (24), p. 4346 describe use of IR-protected PVB and lamination thereof to glass. However, this system does not have the required insulation properties, and moreover exhibits a distinct intrinsic color.

The large selection of IR absorbers described in the prior art does not permit the person skilled in the art to discern which IR absorbers are to be preferred, and how the functional layers are to be arranged in relation to one another in order to achieve the object. Nor is the person skilled in the art able to decide which of the systems for said application provide high weathering resistance.

It is an object of the invention to provide an insulated glazing unit which has good thermal insulation properties and simultaneously reduced transmission of NIR without, by way of example, any need for integration of an expensive metal layer. For the purposes of the present invention, NIR means transmission in the near region of the infrared spectrum from 780 nm to 2500 nm. The element is moreover intended to be less heavy than the corresponding triple glazing systems of the prior art made of glass, and to be highly capable of resisting external effects such as attempted burglaries. The window element is moreover intended to exhibit low UV transmission. It is moreover important that these properties remain substantially constant over a long period and are not subject to drastic change on exposure to weathering effects. A further intention is that the structure of the element be such as to give maximal light transmission with maximal color neutrality: the color coordinates a* and b* in the Lab system are intended to be within the range from −4 to +4, preferably in the range from −3 to +3 (where the color can be determined by way of example with reference to ASTM E1348 by using the weighting factors and formulae described in ASTM E308). The object is achieved via a triple element comprising, in the following sequence:
A) a first glass pane,
B) a further pane comprising or consisting of polycarbonate, and
C) a further glass pane,
   where the triple element is characterized in that a filler gas is present between the individual panes, preferably air, Ar, Kr, Xe, He, SF₆, or CO₂, and that the polycarbonate comprises at least one nanoscale inorganic pigment.

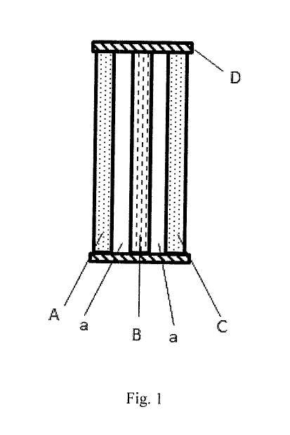

Surprisingly, the object is achieved in that a certain construction is selected in which the polycarbonate pane equipped with specific nanoscale pigments is arranged between two glass panes, as shown by way of example in FIG. 1.

Surprisingly, it has been found that if, in contrast, the polycarbonate pane has direct exposure to the ambient air the IR-protective effect of the entire system is distinctly smaller over the course of time. The person skilled in the art would, however, expect the IR-protective effect to be independent of the arrangement of the panes.

The object has been achieved via an insulated glazing unit (IGU) (see FIG. 1 as possible embodiment) comprising, in the following sequence:
A. a first—optionally additionally coated—glass pane
B. a further—optionally coated—pane made of polycarbonate
C. a further—optionally additionally coated—glass pane,
characterized in that the pane B. is at a distance from each of the glass panes A. and C., and moreover the volumes resulting from said distance have been filled with at least one gas selected from the group consisting of air, neon, argon, krypton, xenon, helium, sulfur hexafluoride, and carbon dioxide, and also mixtures of these, particularly preferably air, argon, krypton, and xenon, and also mixtures of these, and very particularly preferably argon and krypton, and mixtures of these, and the polycarbonate comprises specific nanoscale inorganic particles.

In the abovementioned insulated glazing unit, or the triple element, the individual panes are typically parallel at a distance from one another, thus giving the abovementioned volumes or cavities. The insulated glazing unit or the triple element can moreover have a peripheral edge-bonding system secured on the edges of the panes, thus enclosing the gas provided between the panes.

In the case of the abovementioned optionally coated glass panes, coatings are used which comprise a multilayer system made of at least one metal layer based on gold, silver, copper, indium, tin, or aluminum, the thickness of these being a few nanometers.

It is preferable that the glazing element has a gastight edge-bonding system with an annual transmission rate of at most 1% of the filler gas.

A particular advantage of the invention is the high level of blocking effect with respect to NIR radiation. The temperature rise in the interior by way of example of a building is therefore smaller than if a triple system without NIR-blocking effect were to be used. However, heat transmission due to convection is significantly reduced by virtue of the triple arrangement of the panes in combination with the filler gases. A further advantage is achieved through the use of polycarbonate, which has a lower coefficient of thermal conductivity than glass.

It is preferable that energy transmission at the time t=0 (i.e. without weathering), known as “direct solar energy transmission” or Tds, is less than 50%, preferably less than 45%, and with particular preference less than 42%. The window element is moreover intended to have high UV absorption which expressed as optical density preferably greater than or equal to 1 at wavelength 340 nm, particularly preferably greater than or equal to 1.5, very particularly preferably greater than or equal to 2. Light transmittance is preferably at least 40%, particularly preferably at least 50%, and very particularly preferably greater than 60%.

It is preferable that no, or only slight, changes occur to the data relating to light transmission and energy transmission on exposure to weathering. In particular, it is preferable that absolute light transmittance measured after 500 hours of weathering (weathering in a cabinet under controlled climatic conditions at 90° C. and 90% relative humidity) does not undergo more than 2% change. By analogy, the Tds value undergoes less than 6% change, preferably less than 5%.

For the purposes of the insulated glazing unit of the invention, the glass panes A. and C. are characterized in that their thickness is mutually independently from 2 mm to 10 mm, preferably from 3 mm to 8 mm.

It is preferable that the glass panes are composed of conventional float glass, e.g. alkali-lime glass, preferably sodium-lime glass.

The polycarbonate pane B) either has one layer or takes the form of a multilayer polycarbonate system comprising a polycarbonate layer and further functional layers applied to one or both sides thereof, and has a total thickness of from 2 mm to 15 mm, preferably from 3 mm to 10 mm, and with particular preference from 4 mm to 8 mm.

The structure of insulated glazing units comprising a gastight edge-bonding system with annual filler gas transmission rate of at most 1% of filler gas, made of two or more glass panes or combinations of glass panes with plastics panes, is known. It usually also uses sealants and/or adhesives, and spacers, and also desiccants, alongside the glass panes and/or plastics panes.

The spacer is composed mainly of metal (generally aluminum or stainless steel), and is in the edge region of the panes, and has the task of providing the desired distance between the panes. The distance between the individual panes is preferably from 6 mm to 16 mm, particularly preferably from 6 mm to 12 mm. In the interior of the hollow spacer there is additionally a desiccant present (e.g. a molecular sieve or zeolite), in order to maintain dryness of the volume of air or gas enclosed in the space between the panes. In order that the desiccant can actually absorb moisture, that side of the spacer that faces toward the space between the panes has small apertures (longitudinal perforation). This prevents condensation of moisture on the internal sides of the panes at low ambient temperatures with resultant optical impairment.

Between those sides of the spacer that face toward the panes and the interior surfaces of the panes there is what is known as a primary seal based on polyisobutylene and/or butyl rubber. The function of the primary seal is

a) to be a sort of “assembly aid” when the spacer, precoated with the primary seal, is brought together with the panes during the production of the insulating glazing, so that this connection is retained for the next steps in the production process, and
b) subsequently during the “lifetime” of the insulated glazing unit to form a water-vapor barrier for moisture penetrating from the outside into the space between the panes, and in the case of gas-filled units preventing loss of the filler gas from the space between the panes to the outside.

Since the peripheral outside edge of the spacer is recessed by some millimeters with respect to the outside edges of the panes, a “groove” is formed. What is known as the secondary seal is injected into this unoccupied space, and primarily has the function of providing resilient adhesive bonding of the edge of the insulated glazing unit (panes and spacers), and likewise to a certain extent additionally of forming a seal in relation to water/water vapor from the outside and gas from the inside (space between the panes). The secondary seal is generally composed of room-temperature-crosslinking two-component sealants or, respectively, adhesives based on polysulfide, polyurethane, or silicone. It is also possible to use single-component systems, e.g. based on silicone, or on a hot-applied butyl hot-melt adhesive.

Spacers extruded directly onto a pane in particular eliminate inter alia disadvantages relating to the production process for the abovementioned metal-based spacers, and a substantially more flexible and more productive automated production process for insulating glazing has become possible.

The thermoplastic material used combines the function of the spacer with that of the “primary seal”, and also comprises the desiccant. An example here is what is known as the TPS system (TPS=thermoplastic spacer). A preferred product available commercially is the Super Spacer® from Edgetech, where the conventional metallic spacer has been replaced by a heat-fixed silicone foam matrix.

In these systems, too, the peripheral outside edge of the spacer is recessed by some millimeters below the outside edges of the panes, and the remaining unoccupied space has been filled with the “secondary seal” which provides resilient adhesive bonding of the units.

In the case of silicone as secondary seal, it has been found that combination with a thermoplastic spacer, e.g. the TPS system, permits substantially more reliable production of elements which retain their gastight edge connection even after prolonged weathering cycles; these can be noble-gas-filled elements (EP 916 801 A2).

The argon gas transmission rate of an insulated glazing unit is determined in accordance with EN 1279-3:2002 D “Insulating glass units—Part 3: Long term test method and requirements for gas leakage rate and for gas concentration tolerances”.

The polycarbonate pane B. here comprises at least one nanoscale inorganic IR-absorbing pigment. These materials can be antimony derivatives such as antimony tin oxides or indium derivatives such as indium tin oxides, tungsten derivatives such as specific tungsten oxides, or borides such as lanthanum hexaboride.

A selection of materials of this type is described by way of example in J. Fabian, H. Nakazumi, H. Matsuoka, Chem. Rev. 92, 1197 (1992), or in U.S. Pat. No. 5,712,332 or JP-A 06240146. EP 1865027 A1 describes polymer compositions made of specific polycarbonates which additionally comprise lanthanum hexaboride as IR absorber. US2006/0251996 describes inorganic IR absorbers, among which are inter alia tungstates used as IR-absorbing particles.

However, no document describes the use of these pigments with multiple glazing elements for the glazing of buildings. Long term properties in glazing of buildings is not presented in any document or derivable from said documents. Because of the large number of IR absorbers described and available, it is impossible for the person skilled in the art to discern which specific pigments are suitable for glazing of buildings.

In one particular embodiment, nanoscale particles based on lanthanum hexaboride, preferably present in an acrylate dispersion, can be used as IR absorber. This is advantageous if the desired perceived color is green.

However, in most applications a neutral perceived color is desired. Nanoparticles based on tungstate are therefore in particular preferred for the purposes of the present invention.

The tungstates to be used in the invention are substances of the following type:

a1) WyOz (W=tungsten, 0=oxygen; z/y=2.20-2.99), and/or
a2) MxWyOz (M=H, He, alkali metal, alkaline earth metal, metal from the group of the rare earths, Mg, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi; x/y=0.001-1.000; z/y=2.2-3.0), where preference is given to the elements H, Cs, Rb, K, Tl, In, Ba, Li, Ca, Sr, Fe, and Sn as M, and among these very particular preference is given to Cs. Ba0.33WO3, T10.33WO3, K0.33WO3, Rb0.33WO3, Cs0.33WO3, Na0.33WO3, Na0.75WO3, and also mixtures of these, are particularly preferred.

In one particular embodiment of the present invention, very particular preference is given to the sole use of Cs0.33WO3 as inorganic IR absorber. Compounds with Cs/W ratios of 0.20 and 0.25 are likewise known.

In another preferred embodiment, zinc-doped tungstates are used.

In the case of the tungstates, there is absolutely no restriction in respect of the tungstate content in the glazing elements of the invention. However, it is preferable that the quantity of the tungstates used is from 0.0001% by weight to 10.0000% by weight, particularly from 0.0010% by weight to 1.0000% by weight, and very particularly from 0.0020% by weight to 0.5000% by weight, calculated as solids content of tungstate or of zinc-doped tungstate in the entire polymer composition.

In one particular embodiment of the invention, the quantity of the tungstates of the invention used is from 0.0090% by weight to 0.0500% by weight, again stated as solids content of tungstate in the entire polymer composition. In this context, solids content of tungstate means the tungstate as pure substance and not a dispersion, suspension or other preparation comprising the pure substance, and the tungsten content data below always relate to this solids content unless explicitly otherwise stated.

It is preferable to use these concentrations for polycarbonate panes with thicknesses of from 2 to 15 mm, preferably from 3 to 10 mm, and with particular preference from 4 to 8 mm.

The average particle diameter of the nanoscale particles used in the invention (preferably tungstates) is preferably smaller than 200 nm, particularly preferably smaller than 100 nm. The particles permit passage of light in the visible region of the spectrum, and this means that the absorption of these IR absorbers in the visible region is small in comparison with the absorption in the IR region, and that the IR absorber does not lead to any significantly increased haze or significant reduction of transmittance (in the visible region) of the composition or of the respective final product.

The tungstates of type a2) have an amorphous, cubic, tetragonal, or hexagonal tungsten-bronze structure, where M is preferably H, Cs, Rb, K, Tl, Ba, In, Li, Ca, Sr, Fe, and Sn.

Materials of this type are produced by, for example, mixing tungsten trioxide, tungsten dioxide, a hydrate of a tungsten oxide, tungsten hexachloride, ammonium tungstate, or tungstic acid, and optionally other salts comprising the element M, e.g. cesium carbonate, in certain stoichiometric ratios in such a way that the molar ratios of the individual components are given by the formula MxWyOz. This mixture is then treated at temperatures of from 100° C. to 850° C. in a reducing atmosphere, e.g. an argon-hydrogen atmosphere, and finally the resultant powder is heat conditioned under inert gas at temperatures of from 550° C. to 1200° C.

The inorganic IR-absorber nanoparticles of the invention can be produced by mixing the IR absorber with the dispersion media described at a later stage below and other organic solvents, e.g. toluene, benzene, or similar aromatic hydrocarbons, and grinding in suitable mills, e.g. ball mills, with addition of zirconium oxide (e.g. with diameter 0.3 mm), in order to produce the desired particle size distribution. The nanoparticles are obtained in the form of a dispersion. Further dispersion media can optionally be added after grinding. The solvent is removed at elevated temperatures and reduced pressure. The average size of nanoparticles is preferably smaller than 200 nm, particularly preferably smaller than 100 nm.

The size of the particles can be determined by using transmission electron spectroscopy (TEM). Measurements of this type on IR-absorber nanoparticles are described by way of example in Adachi et al., J. Am. Ceram. Soc. 2008, 91, 2897-2902.

The production of the tungstates of the invention is described in more detail by way of example in EP 1 801 815 A1, and they are available commercially by way of example as YMDS 874 from Sumitomo Metal Mining Co., Ltd. (Japan).

For the use in transparent thermoplastics, the resultant particles are dispersed in an organic matrix, e.g. in an acrylate, and optionally ground as described above in a mill with use of suitable auxiliaries, e.g. zirconium dioxide, and optionally with use of organic solvents, for example toluene, benzene, or similar hydrocarbons.

Suitable polymer-based dispersion media are especially dispersion media which have high light transmittance, e.g. polyacrylates, polyurethanes, polyethers, polyesters, or polyester urethanes, and also polymers derived therefrom.

Preferred dispersion media are polyacrylates, polyethers, and polyester-based polymers and particularly preferred high-temperature resistant dispersion media here are polyacrylates, e.g. polymethyl methacrylate, and polyesters. It is also possible to use mixtures of said polymers or else copolymers based on acrylate. Dispersion aids of this type and methods for the production of tungstate dispersions are described by way of example in JP 2008214596, and also in Adachi et al. J. Am. Ceram. Soc. 2007, 90 4059-4061.

Dispersion media suitable for the present invention are available commercially. Dispersion media based on polyacrylate are particularly suitable. Dispersion media with this type of suitability are available by way of example with trademarks EFKA®, e.g. EFKA® 4500, and EFKA® 4530 from Ciba Specialty Chemicals. Polyester-containing dispersion media are likewise suitable. They are available by way of example with trademarks Solsperse®, e.g. Solsperse® 22000, 24000SC, 26000, 27000 from Avecia. Polyether-containing dispersion media are also known, e.g. with trademarks Disparlon® DA234 and DA325 from Kusumoto Chemicals. Polyurethane-based systems are also suitable. Polyurethane-based systems are available with trademarks EFKA® 4046, EFKA® 4047 from Ciba Specialty Chemicals. Texaphor® P60 and P63 are corresponding trademarks of Cognis.

The quantity of the IR absorber in the dispersion medium is 0.2% by weight to 50.0% by weight, preferably from 1.0% by weight to 40.0% by weight, more preferably from 5% by weight to 35% by weight, and most preferably from 10% by weight to 30% by weight, based on the dispersion used in the invention comprising the inorganic IR absorber. The entire composition of the ready-to-use IR absorber formulation can also comprise, alongside the IR absorber as pure substance and the dispersion medium, other auxiliaries such as zirconium dioxide, and also residual solvents such as toluene, benzene, or similar aromatic hydrocarbons.

In another embodiment, it is optionally possible to use, alongside the tungstates of the invention as IR absorbers, other additional IR absorbers, where the content of these in a mixture of this type, in relation to quantity and/or performance, is however less than that of the tungstates described above. Preferred compositions here for mixtures comprise from two up to, and inclusive of, five different IR absorbers, and particularly two or three.

The further optional IR absorber is preferably selected from the group of the borides and tin oxides, particularly preferably LaB6 or antimony-doped tin oxide, or indium tin oxide.

In an alternative embodiment of the present invention, the polymer composition of the invention comprises no inorganic IR absorbers at all of the metal borides type, for example lanthanum hexaboride, LaB₆.

In another preferred embodiment, the absorption spectrum of the additional IR absorber(s) differs from that of the tungstate used in respect of the absorption maxima, in such a way that the maxima cover a maximal absorption range.

Suitable additional organic infrared absorbers are described according to classes of substance by way of example in M. Matsuoka, Infrared Absorbing Dyes, Plenum Press, New York, 1990. Infrared absorbers from the following classes are particularly suitable: the phthalocyanines, the naphthalocyanines, the metal complexes, the azo dyes, the anthraquinones, the quadratic acid derivatives, the immonium dyes, the perylenes, the quaterylenes, and also the polymethines. Among these, phthalocyanines and naphthalocyanines are very particularly suitable. A particular resultant effect is that certain absorptions in narrow ranges can be combined with the absorption due to the inorganic pigments.

Phthalocyanines and naphthalocyanines having bulky pendant groups, for example phenyl, phenoxy, alkylphenyl, alkylphenoxy, tert-butyl, (—S-phenyl), —NH-aryl, —NH-alkyl, and similar groups, are preferable because of better solubility in thermoplastics.

It is moreover possible to add compounds such as indium oxide which has from 2 to 30 atom %, preferably from 4 to 12 atom %, tin doping (ITO), or which has from 10 to 70 atom % fluorine doping.

Particular preference is given to the combination of tin oxide as further IR absorber which has from 2 to 60 atom % of antimony doping (ATO), or has from 10 to 70 atom % fluorine doping.

Another particularly suitable material is zinc oxide which has from 1 to 30 atom %, preferably from 2 to 10 atom %, aluminum doping, or which has from 2 to 30 atom % indium doping, or which has from 2 to 30 atom % gallium doping.

Mixtures of the abovementioned infrared absorbers are particularly suitable, since by using a specific selection the person skilled in the art can achieve optimization of absorption in the near infrared region.

The polycarbonate for the polycarbonate pane B. moreover preferably comprises at least one mold-release agent.

The quantity used here of one or more mold-release agents, based on the total quantity of mold-release agents, is from 0.0% by weight to 1.0% by weight, preferably from 0.01% by weight to 0.50% by weight, particularly preferably from 0.01% by weight to 0.40% by weight. Particularly suitable mold-release agents for the composition of the invention are pentaerythritol tetrastearate (PETS) and glycerol monostearate (GMS).

It is preferable that the polycarbonate for the polycarbonate pane B. comprises at least one UV absorber.

The quantity used of at least one or more UV absorbers here, based on the total quantity of UV absorbers, is from 0.0% by weight to 20.00% by weight, preferably from 0.05% by weight to 10.00% by weight, more preferably from 0.10% by weight to 1.00% by weight, still more preferably from 0.10% by weight to 0.50% by weight, or else very particularly preferably from 0.10% by weight to 0.30% by weight; or from 0.00% by weight to 20.00% by weight, preferably from 0.05% by weight to 10.00% by weight, more preferably from 0.10% by weight to 1.00% by weight, still more preferably from 0.10% by weight to 0.50% by weight, or else very particularly preferably from 0.10% by weight to 0.30% by weight, of at least one UV absorber.

Suitable UV absorbers are described by way of example in EP 1 308 084 A1, in DE 102007011069 A1, and also in DE 10311063 A1.

Particularly suitable ultraviolet absorbers are based on benzotriazoles, triazines, and biphenyltriazines, and also in particular hydroxybenzotriazoles, such as 2-(3′,5′-bis(1,1-dimethylbenzy1)-2′-hydroxyphenyl)-benzotriazole (Tinuvin® 234, Ciba Spezialitatenchemie, Basle), 2-(2′-hydroxy-5′-(tert-octyl)phenyl)-benzotriazole (Tinuvin® 329, Ciba Spezialitatenchemie, Basle), 2-(2′-hydroxy-3′-(2-butyl)-5′-(tert-butyl)-phenyl)benzotriazole (Tinuvin® 350, Ciba Spezialitatenchemie, Basle), bis(3-(2H-benzotriazolyl)-2-hydroxy-5-tert-octyl)methane, (Tinuvin® 360, Ciba Spezialitatenchemie, Basle), (2-(4,6-diphenyl-1,3,5-triazin-2-yl)-5-(hexyloxy)phenol (Tinuvin® 1577, Ciba Spezialitatenchemie, Basle), and also the benzophenones 2,4-dihydroxybenzophenone (Chimassorb® 22, Ciba Spezialitatenchemie, Basle) and 2-hydroxy-4-(octyloxy)benzophenone (Chimassorb® 81, Ciba, Basle), 2-propenoic acid, 2-cyano-3,3-diphenyl-, 2,2-bis[[(2-cyano-1-oxo-3,3-diphenyl-2-propenyl)oxy]methyl]-1,3-propanediyl ester (9CI) (Uvinul® 3030, BASF AG Ludwigshafen), 2-[2-hydroxy-4-(2-ethylhexyl)oxy]phenyl-4,6-di(4-phenyl)phenyl-1,3,5-triazines (Tinuvin 1600, Ciba Spezialitatenchemie, Basle), and tetraethyl 2,2′-(1,4-phenylenedimethylidene)bismalonate (Hostavin® B-Cap, Clariant AG). It is also possible to use mixtures of these ultraviolet absorbers.

The polycarbonate moreover preferably comprises processing stabilizers and/or heat stabilizers.

From 0.00% by weight to 0.20% by weight, preferably from 0.01% by weight to 0.10% by weight, of one or more heat/processing stabilizers is used here, based on the entire quantity of heat/processing stabilizers, preferably selected from the group of the phosphines, phosphites and phenolic antioxidants and mixtures of these. One specific embodiment of the present invention uses from 0.01% by weight to 0.05% by weight, preferably from 0.015% by weight to 0.040% by weight, of heat/processing stabilizers.

Examples are triphenyl phosphite, diphenyl alkyl phosphite, phenyl dialkyl phosphite, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,4-dicumylphenyl) pentaerythritol diphosphite, bis(2,6-di-tert-butyl-4-methylphenyl) pentaerythritol diphosphite, diisodecyloxy pentaerythritol diphosphite, bis(2,4-di-tert-butyl-6-methylphenyl) pentaerythritol diphosphite, bis(2,4,6-tris(tert-butyl)phenyl) pentaerythritol diphosphite, tristearyl sorbitol triphosphite, tetrakis(2,4-di-tert-butylphenyl) 4,4′-biphenylenediphosphonite, 6-isooctyloxy-2,4,8,10-tetra-tert-butyl-12H-dibenzo[d,g]-1,3,2-dioxaphosphocine, bis(2,4-di-tert-butyl-6-methylphenyl) methyl phosphite, bis(2,4-di-tert-butyl-6-methylphenyl) ethyl phosphite, 6-fluoro-2,4,8,10-tetra-tert-butyl-12-methyldibenzo[d,g]-1,3,2-dioxaphosphocine, 2,2′,2″-nitrilo[triethyltris(3,3′,5,5′-tetra-tert-butyl-1,1′-biphenyl-2,2′-diyl) phosphite], 2-ethylhexyl (3,3′,5,5′-tetra-tert-butyl-1,1′-biphenyl-2,2′-diyl) phosphite, 5-butyl-5-ethyl-2-(2,4,6-tri-tert-butylphenoxy)-1,3,2-dioxaphosphirane, bis(2,6-di-tert-butyl-4-methylphenyl) pentaerythritol diphosphite, triphenylphosphine (TPP), trialkylphenylphosphine, bisdiphenylphosphinoethane, or a trinaphthylphosphine. It is particularly preferable to use triphenylphosphine (TPP), Irgafos® 168 (tris(2,4-di-tert-butylphenyl) phosphite), and tris(nonylphenyl) phosphite, or a mixture of these.

It is moreover possible to use phenolic antioxidants such as alkylated monophenols, alkylated thioalkylphenols, hydroquinones, and alkylated hydroquinones. It is particularly preferable to use Irganox® 1010 (pentaerythritol 3-(4-hydroxy-3,5-di-tert-butylphenyl)propionate; CAS: 6683-19-8) and Irganox 1076® (2,6-di-tert-butyl-4-(octadecanoxycarbonylethyl)phenol).

In one preferred embodiment the polycarbonate comprises specific phosphates, in particular alkyl phosphates.

Examples of suitable alkyl phosphates are mono-, di- and trihexyl phosphate, triisooctyl phosphate, and trinonyl phosphate. It is preferable to use triisooctyl phosphate (tris-2-ethylhexyl phosphate) as alkyl phosphate. Mixtures of various mono-, di-, and trialkyl phosphates can also be used. The quantities used of the alkyl phosphates are less than 500 mg/kg, preferably from 0.5 to 500 mg/kg, particularly preferably from 2 to 500 mg/kg, very particularly preferably from 5 to 300 mg/kg, and in a very preferred case from 10 to 120 mg/kg, based on the total weight of the composition.

Mixtures of a plurality of transparent thermoplastic polymers can also be used, in particular when they can form a transparent mixture, and in a specific embodiment here preference is given to a mixture of polycarbonate with PMMA (more preferably with <2% by weight of PMMA) or polyester. Suitable polycarbonates for the production of the polycarbonate pane B. are any of the known polycarbonates. These are homopolycarbonates, copolycarbonates, and thermoplastic polyester carbonates.

The average molecular weights M̅ w of suitable polycarbonates are preferably from 10 000 to 50 000, with preference from 14 000 to 40 000, and in particular from 16 000 to 32 000, determined via gel permeation chromatography with polycarbonate calibration. The polycarbonates are preferably produced by the interfacial process or the melt transesterification process, these being widely described in the literature.

In relation to the interfacial process reference may be made by way of example to H. Schnell, “Chemistry and Physics of Polycarbonates”, Polymer Reviews, vol. 9, Interscience Publishers, New York 1964, pp. 33 ff., to Polymer Reviews, Vol. 10, “Condensation Polymers by Interfacial and Solution Methods”, Paul W. Morgan, Interscience Publishers, New York 1965, chapter VIII, p. 325, to Dres. U. Grigo, K. Kircher and P. R. Müller “Polycarbonate” in Becker/Braun, Kunststoff-Handbuch [Plastics handbook], volume 3/1, Polycarbonate, Polyacetale, Polyester, Celluloseester [Polycarbonates, polyacetals, polyesters, cellulose esters], Carl Hanser Verlag Munich, Vienna, 1992, pp. 118-145, and also to EP 0 517 044 A1.

The melt transesterification process is described by way of example in Encyclopedia of Polymer Science, vol. 10 (1969), Chemistry and Physics of Polycarbonates, Polymer Reviews, H. Schnell, vol. 9, John Wiley and Sons, Inc. (1964), and also in the patents DE-B 10 31 512 and U.S. Pat. No. 6,228,973.

The polycarbonates are preferably produced via reactions of bisphenol compounds with carbonic acid compounds, in particular phosgene, or in the case of the melt transesterification process diphenyl carbonate or dimethyl carbonate.

Particular preference is given here to homopolycarbonates based on bisphenol-A and copolycarbonates based on the monomers bisphenol A and 1,1-bis(4-hydroxyphenyl)-3,3,5-trimethylcyclohexane.

These and other bisphenol compounds or diol compounds that can be used for the polycarbonate synthesis are disclosed inter alia in WO 2008037364 A1 (p. 7, line 21 to p. 10, line 5), EP 1 582 549 A1 ([0018] to [0034]), WO 2002026862 A1 (p. 2, line 20 to p. 5, line 14), WO 2005113639 A1 (p. 2, line 1 to p. 7, line 20).

The polycarbonates can be linear or branched. It is also possible to use mixtures of branched and unbranched polycarbonates.

Suitable branching agents for polycarbonates are known from the literature and described by way of example in the patents U.S. Pat. No. 4,185,009 and DE 25 00 092 A1 (3,3-bis(4-hydroxyaryloxindoles) of the invention, see entire document in each case), DE 42 40 313 A1 (see p. 3, lines 33 to 55), DE 19 943 642 A1 (see p. 5, lines 25 to 34) and U.S. Pat. No. 5,367,044, and also literature cited therein.

It is moreover also possible that the polycarbonates used have intrinsic branching, and in this case no branching agent is added during the course of production of the polycarbonate. The structures known as Fries structures disclosed in EP 1 506 249 A1 for melt polycarbonates are an example of intrinsic branching.

It is moreover possible to use chain terminators during the production of the polycarbonate. Chain terminators used are preferably phenols such as phenol, alkylphenols such as cresol and 4-tert-butylphenol, chlorophenol, bromophenol, cumylphenol, or a mixture of these.

The polycarbonate composition of the invention for the polycarbonate pane B. can comprise other additives; the abovementioned are excluded here. The other additives are conventional polymer additives, e.g. the processing aids, colorants, inorganic pigments, flow improvers, optical brighteners, or flame retardants described in EP-A 0 839 623, WO-A 96/15102, EP-A 0 500 496, or “Plastics Additives Handbook”, Hans Zweifel, 5th edition 2000, Hanser Verlag, Munich. In this connection, the abovementioned substances already disclosed as components of the present invention are expressly not a constituent of this additional additive component.

The composition must be processable at the temperatures conventional for thermoplastics, i.e. temperatures above 300° C., e.g. 350° C., without any significant alteration of color or of performance data during processing.

The polymer compositions used in the invention, comprising the abovementioned additives, are produced by familiar incorporation processes via combination, mixing, and homogenization, where in particular the homogenization preferably takes place in the melt with exposure to shear forces. The combination and mixing optionally take place before homogenization in the melt, with use of powder premixes.

It is also possible to use premixes produced from solutions of the mixture components in suitable solvents, with the option of homogenization in solution, and subsequent removal of the solvent.

In particular here, the components of the composition of the invention can be introduced via known processes, inter alia in the form of masterbatch.

The use of masterbatches, and also of powder mixtures or compacted premixes, is particularly suitable for the introduction of the abovementioned additives. It is possible here, if desired, to premix all of the abovementioned components. A possible alternative, however, is use of premixes. In order to improve metering capability during the production of the thermoplastic polymer compositions, it is preferable in all cases that sufficient pulverulent polymer component is added to the abovementioned additives to produce total volumes that are easy to handle.

In one particular embodiment the abovementioned components can be mixed to give a masterbatch, and this mixing preferably takes place in the melt with exposure to shear forces (for example in a kneader or twin-screw extruder). This process has the advantage of better distribution of the components in the polymer matrix. When producing the masterbatch it is preferable to select, as polymer matrix, the thermoplastic that is also the main component of the final overall polymer composition.

This composition can be combined in conventional devices such as screw-based extruders (e.g. twin-screw extruders, TSE), kneaders, Brabender mixers, or Banbury mixers, mixed, homogenized, and then extruded. The extrudate can be cooled and comminuted. It is also possible to premix individual components and then to add the remaining starting materials individually and/or likewise in a mixture.

The polymer compositions of the invention can be processed to give the appropriate sheets suitable for glazing elements by, for example, first extruding the polymer compositions as described to give pellets, and processing said pellets in a known manner via suitable processes to give various sheets.

In this context, the compositions of the invention can by way of example be converted via hot pressing, spinning, blowmolding, thermoforming, extrusion, or injection molding to the appropriate products, moldings, or molded sheets or panes. The use of multilayer systems is also of interest. The application process can occur simultaneously or immediately after the shaping of the base, e.g. via coextrusion or multicomponent injection molding. However, the application process can also take place on the finished molded base, e.g. via lamination with a film, or via coating with a solution.

Sheets or moldings made of base layer and of optional outer layer(s) (multilayer systems) can be produced via (co)extrusion, direct skinning, direct coating, insert molding, in-mold coating, or other suitable processes known to the person skilled in the art.

Injection-molding processes are known to the person skilled in the art and are described by way of example in “Handbuch Spritzgiessen” [Injection molding handbook], Friedrich Johannnaber/Walter Michaeli, Munich; Vienna: Hanser, 2001, ISBN 3-446-15632-1, or “Anleitung zum Bau von Spritzgiesswerkzeugen” [Introduction to the construction of injection molds], Menges/Michaeli/Mohren, Munich; Vienna: Hanser, 1999, ISBN 3-446-21258-2.

Extrusion processes are known to the person skilled in the art and by way of example in the case of coextrusion are described inter alia in EP-A 0 110 221, EP-A 0 110 238, and EP-A 0 716 919. For details of the adaptor process and die process see Johannaber/Ast: “Kunststoff-Maschinenführer” [Guide to plastics machinery], Hanser Verlag, 2000, and in Gesellschaft Kunststofftechnik: “Coextrudierte Folien und Platten: Zukunftsperspektiven, Anforderungen, Anlagen und Herstellung, Qualitätssicherung” [Coextruded films and sheets: outlook, requirements, plant and production, quality assurance], VDI-Verlag, 1990.

Products of the invention are glazing systems, for example for architectural glazing, windows of rail vehicles and of aircraft, safety glazing, roof systems, and other glazing in buildings.

FIG. 1 shows a structure of an insulated glazing unit of the invention.

The reference signs in FIG. 1 have the following meanings:
A: glass pane
a: gas fill
B: polycarbonate comprising nanoscale inorganic filler
C: glass pane
D: seal

### EXAMPLES

The invention is described in more detail below with reference to embodiments, and the determination methods described here are used for all corresponding variables in the present invention unless otherwise stated.

Light Transmittance (Ty):

The transmittance measurements were made in a Lambda 900 spectrophotometer from Perkin Elmer with photometer sphere in accordance with ISO 13468-2 (i.e. determination of total transmittance via measurement of diffuse transmittance and direct transmittance).

Color in transmission is determined with a Lambda 900 spectrophotometer from Perkin Elmer with photometer sphere by a method based on ASTM E1348, using the weighting factors and formulae described in ASTM E308.

Determination of TDS Value (Tds, Solar Direct Transmittance):

The transmittance measurements were made in a Lambda 900 spectrophotometer from Perkin Elmer with photometer sphere. All of the values were determined at wavelengths from 320 nm up to and including 2300 nm with Δλ 5 nm.

“Solar Direct Transmittance” TDS was calculated in accordance with ISO 13837, computational convention “A”.

Materials Used:

Polycarbonate: Polymer component used is linear bisphenol A polycarbonate having terminal groups based on phenol with melt volume rate (MVR) 9.5 cm³/10 min, measured at 300° C. with 1.2 kg loading in accordance with ISO 1033 comprising 0.08% by weight of YMDS 874 (cesium tungstate (Cs_{0.33}WO₃) dispersion from Sumitomo Metal Mining, Japan, where the solids content of cesium tungstate in the acrylate dispersion is 25% by weight), 0.025% by weight of Irganox B900 (mixture of 80% of Irgafos 168 and 20% of Irganox 1076; BASF AG; Ludwigshafen), 0.01% of triphenylphosphine (Sigma-Aldrich, 82018 Taufkirchen, Germany), and 0.20% by weight of Tinuvin 329 (2-(benzotriazol-2-yl)-4-(2,4,4-trimethylpentan-2-yl)phenol/CAS No. 3147-75-9 from BASF AG, Ludwigshafen), and 0.25% by weight of pentaerythritol tetrastearate (Cognis Oleochemicals GmbH Dusseldorf).

Glass: semi-tempered soda-lime glass “TVG Optifloat blank”, thickness 4 mm, from Flachglas Wernberg GmbH, hereinafter termed window pane.

Spacer system: Aluminum spacer filled with desiccant

Primary sealant: Naftotherm BU-S(solvent-free polyisobutylene) produced by Kömmerling Chemische Fabriken GmbH

Secondary sealant: Naftotherm M82 (solvent-free polysulfide, two-component) produced by Kommerling Chemische Fabriken GmbH

Production of Polycarbonate Panes:

Polycarbonate Pane

The polycarbonate pane is produced by the injection-molding process. Rectangular injection-molded sheets measuring 150×105×4 mm are produced in optical quality with the abovementioned polycarbonate, with side gating. Melt temperature was from 300 to 330° C., and mold temperature was 100° C. The pellets were dried for 5 hours at 120° C. in a vacuum drying oven before processing.

### Weathering:

The insulating elements mentioned below are subjected to weathering in a cabinet at 90° C. and 90% relative humidity. The optical data are determined after 250 h and 500 h.

### Example 1

### Comparative Example

IGU composed of an external polycarbonate pane A of thickness 4 mm, an internal glass pane B of thickness 4 mm at a distance of 6 mm, and another glass pane B of thickness 4 mm at a distance of 6 mm from the internal glass pane, sealed with a combination of spacer and primary sealant. The intermediate space between the panes is flooded with argon, and the glazing system is then sealed with the secondary sealant. Once the edge-bonding system has been thoroughly dried, the external frame of the IGU is sealed with S53L10M single-sided metal tape from Stokvis Tapes Germany GmbH. The edge regions of the IGUs already adhesive-bonded with S53L10M single-side adhesive metal tape from Stokvis Tapes Germany GmbH were additionally sealed with 92-3033 single-side adhesive polyimide tape from 3M in Neuss. This completely prevented permeation of moisture through the edge-bonding system.

### Example 2

### Comparative Example

IGU composed of an external glass pane B of thickness 4 mm, an internal polycarbonate pane A of thickness 4 mm at a distance of 6 mm, and another glass pane B of thickness 4 mm at a distance of 6 mm from the internal polycarbonate pane, sealed with a combination of spacer and primary sealant. The intermediate space between the panes is flooded with argon, and the glazing system is then sealed with the seal material (secondary sealant). No additional sealing of the frame is carried out.

### Example 3

### Inventive Example

IGU composed of an external glass pane B of thickness 4 mm, an internal polycarbonate pane A of thickness 4 mm at a distance of 6 mm, and another glass pane B of thickness 4 mm at a distance of 6 mm from the internal polycarbonate pane, sealed with a combination of spacer and primary sealant. The intermediate space between the panes is flooded with argon, and the glazing system is then sealed with the secondary sealant. Once the edge-bonding system has been thoroughly dried, the external frame of the IGU is sealed with S53L10M single-side adhesive metal tape from Stokvis Tapes Germany GmbH. The edge regions of the IGUs already adhesive-bonded with S53L10M single-side adhesive metal tape from Stokvis Tapes Germany GmbH were additionally sealed with 92-3033 single-side adhesive polyimide tape from 3M in Neuss. This completely prevented permeation of moisture through the edge-bonding system.

TABLE 1
Optical data before and after weathering:

| | Ty | Ty | Ty | Tds | Tds | Tds |
|---|---|---|---|---|---|---|
| | (0 h) | (250 h) | (500 h) | (0 h) | (250 h) | (500 h) |
| Example 1 | 64.4% | 66.4% | 68.9% | 38.9% | 45.2% | 48.1% |
| (comp.) | | | | | | |
| Example 2 | 64.4% | not | 66.2 | 38.5% | not | 45.3% |
| (comp.) | | measured | | | measured | |
| Example 3 | 64.5% | 67.2% | 66.0% | 38.7% | 42.9% | 43.4% |
| (inv.) | | | | | | |

The initial data for optical properties before weathering are identical for all of the systems within the bounds of accuracy of measurement. After 250 h of weathering, the Tds value increases in Comparative Example 1, and also in Inventive Example 3. Surprisingly, however, the increase of the Tds value in Inventive Example 3 is significantly smaller. The IR-protective effect after weathering is therefore higher in Inventive Example 3. From Comparative Example 1 and Inventive Example 3 it is therefore apparent that, surprisingly, the arrangement of the panes is significant for thermal insulation properties. After 500 hours there is hardly any discernible further rise of the Tds value for the inventive system. In contrast, the IR-protective effect of the IGU of Example 1 continues to decrease. Comparison of Examples 2 and 3 moreover shows that inadequate sealing of the IGUs leads to lower long-term stability in relation to thermal insulation properties.

1.-14. (canceled)

15. A triple element comprising, in the following sequence:
A) a first glass pane,
B) a further pane comprising or consisting of polycarbonate, and
C) a further glass pane,
characterized in that a filler gas is present between the individual panes, preferably air, Ar, Kr, Xe, He, SF₆, or CO₂, and that the polycarbonate comprises at least one nanoscale inorganic pigment.

16. The triple element as claimed in claim 15, characterized in that the average particle diameter of the nanoscale inorganic pigment is less than 200 nm.

17. The triple element as claimed in claim 15, characterized in that the polycarbonate comprises a nanoscale pigment based on tungstate.

18. The triple element as claimed in claim 15, characterized in that at least one of the panes A), B), or C) has also been coated.

19. The triple element as claimed in claim 15, characterized in that the filler gas is air, argon, or krypton.

20. The triple element as claimed in claim 19, characterized in that the filler gas is argon or krypton.

21. The triple element as claimed in claim 15, characterized in that the distance between the panes is from 6 mm to 12 mm, and the thickness of the polycarbonate pane is from 2 mm to 15 mm.

22. The triple element as claimed in claim 17, characterized in that the concentration of tungstate, based on solids content, is from 0.0001% by weight to 10.0000% by weight in the entire polymer composition.

23. The triple element as claimed in claim 22, characterized in that the concentration of tungstate, based on the solids content, is from 0.0001% by weight-0.0500% by weight in the entire polymer composition.

24. The triple element as claimed in claim 17, characterized in that the central polycarbonate pane comprises cesium tungstate or zinc-doped cesium tungstate.

25. The triple element as claimed in claim 15, characterized in that the polycarbonate comprises at least one UV absorber based on benzotriazoles, triazines, and biphenyltriazines, and at least one mold-release agent.

26. The triple element as claimed in claim 15, characterized in that the central pane B) is a multilayer system consisting of a superposed UV-protection layer and of a polycarbonate substrate layer situated thereunder.

27. The triple element as claimed in claim 15, characterized in that the polycarbonate comprises triphenylphosphine.

28. The use of a triple element as claimed in claim 15 for glazing systems, including architectural glazing, windows of rail vehicles and of aircraft, safety glazing, roof systems, and other glazing in buildings.
